(19) United States
(12) Patent Application Publication
(10) Pub. No.: US 2024/0170844 A1
(43) Pub. Date: May 23, 2024

(54) MOBILE DEVICE SUPPORTING WIDEBAND OPERATION

(71) Applicant: Acer Incorporated, New Taipei City (TW)

(72) Inventors: Kun-Sheng CHANG, New Taipei City (TW); Ching-Chi LIN, New Taipei City (TW)

(21) Appl. No.: 18/156,051

(22) Filed: Jan. 18, 2023

(30) Foreign Application Priority Data
Nov. 23, 2022 (TW) 111144731

(51) Int. Cl. H01Q 5/307; H01Q 1/22; H01Q 1/48; H01Q 9/04; H01Q 21/24

(52) U.S. Cl. CPC H01Q 5/307; H01Q 1/2266; H01Q 1/48; H01Q 9/0421; H01Q 21/24

(57) ABSTRACT

A mobile device supporting wideband operations includes a feeding radiation element, a first radiation element, a second radiation element, a shorting radiation element, a third radiation element, and a fourth radiation element. The feeding radiation element has a feeding point. The first radiation element is coupled to the feeding radiation element. The second radiation element is coupled to the feeding radiation element. The second radiation element and the first radiation element substantially extend in opposite directions. The second radiation element is coupled through the shorting radiation element to a ground voltage. The third radiation element is coupled to the ground voltage. The fourth radiation element is coupled to the feeding radiation element. An antenna structure is formed by the feeding radiation element, the first radiation element, the second radiation element, the shorting radiation element, the third radiation element, and the fourth radiation element.

### CROSS REFERENCE TO RELATED APPLICATIONS

This application claims priority of Taiwan Patent Application No. 111144731 filed on Nov. 23, 2022, the entirety of which is incorporated by reference herein.

### BACKGROUND OF THE INVENTION

### Field of the Invention

The disclosure generally relates to a mobile device, and more particularly, to a mobile device supporting wideband operations.

### Description of the Related Art

With the advancements being made in mobile communication technology, mobile devices such as portable computers, mobile phones, multimedia players, and other hybrid functional portable electronic devices have become more common. To satisfy consumer demand, mobile devices can usually perform wireless communication functions. Some devices cover a large wireless communication area; these include mobile phones using 2G, 3G, and LTE (Long Term Evolution) systems and using frequency bands of 700 MHz, 850 MHz, 900 MHz, 1800 MHz, 1900 MHz, 2100 MHz, 2300 MHz, and 2500 MHz. Some devices cover a small wireless communication area; these include mobile phones using Wi-Fi systems and using frequency bands of 2.4 GHz, 5.2 GHz, and 5.8 GHz.

Antennas are indispensable elements for wireless communication. If an antenna for signal reception and transmission has insufficient operational bandwidth, it may impact the communication quality of the mobile device in question. Accordingly, it has become a critical challenge for designers to design a small-size, wideband antenna structure.

### BRIEF SUMMARY OF THE INVENTION

In an exemplary embodiment, the invention is directed to a mobile device supporting wideband operations. The mobile device includes a feeding radiation element, a first radiation element, a second radiation element, a shorting radiation element, a third radiation element, and a fourth radiation element. The feeding radiation element has a feeding point. The first radiation element is coupled to the feeding radiation element. The second radiation element is coupled to the feeding radiation element. The second radiation element and the first radiation element substantially extend in opposite directions. The second radiation element is coupled through the shorting radiation element to a ground voltage. The third radiation element is coupled to the ground voltage. The third radiation element is adjacent to the first radiation element. The fourth radiation element is coupled to the feeding radiation element. The fourth radiation element is adjacent to the second radiation element. An antenna structure is formed by the feeding radiation element, the first radiation element, the second radiation element, the shorting radiation element, the third radiation element, and the fourth radiation element.

In some embodiments, the combination of the feeding radiation element, the first radiation element, and the second radiation element substantially has a T-shape.

In some embodiments, the mobile device further includes a fifth radiation element coupled to the ground voltage. The fifth radiation element is adjacent to the fourth radiation element.

In some embodiments, the mobile device further includes a dielectric substrate. The feeding radiation element, the first radiation element, the second radiation element, the shorting radiation element, the third radiation element, the fourth radiation element, and the fifth radiation element are disposed on the dielectric substrate.

In some embodiments, a first coupling gap is formed between the third radiation element and the first radiation element. A second coupling gap is formed between the fourth radiation element and the second radiation element. A third coupling gap is formed between the fifth radiation element and the fourth radiation element. The width of each of the first coupling gap, the second coupling gap, and the third coupling gap is from 0.5 mm to 1 mm.

In some embodiments, the antenna structure covers a first frequency band, a second frequency band, a third frequency band, and a fourth frequency band. The first frequency band is from 1805 MHz to 2170 MHz. The second frequency band is from 2300 MHz to 2700 MHz. The third frequency band is from 3300 MHz to 3800 MHz. The fourth frequency band is from 4400 MHz to 5000 MHz.

In some embodiments, the total length of the first radiation element and the second radiation element is substantially equal to 0.25 wavelength of the first frequency band.

In some embodiments, the total length of the feeding radiation element and the first radiation element is substantially equal to 0.25 wavelength of the second frequency band.

In some embodiments, the length of the third radiation element is substantially equal to 0.25 wavelength of the third frequency band.

In some embodiments, the length of the fifth radiation element is substantially equal to 0.25 wavelength of the fourth frequency band.

### BRIEF DESCRIPTION OF DRAWINGS

The invention can be more fully understood by reading the subsequent detailed description and examples with references made to the accompanying drawings, wherein:

FIG. 1 is a top view of a mobile device according to an embodiment of the invention;

FIG. 2 is a top view of a mobile device according to an embodiment of the invention;

FIG. 3 is a diagram of radiation efficiency of an antenna structure of a mobile device according to an embodiment of the invention; and

FIG. 4 is a perspective view of a notebook computer according to an embodiment of the invention.

### DETAILED DESCRIPTION OF THE INVENTION

In order to illustrate the purposes, features and advantages of the invention, the embodiments and figures of the invention are shown in detail as follows.

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. The term “substantially” means the value is within an acceptable error range. One skilled in the art can solve the technical problem within a predetermined error range and achieve the proposed technical performance. Also, the term “couple” is intended to mean either an indirect or direct electrical connection. Accordingly, if one device is coupled to another device, that connection may be through a direct electrical connection, or through an indirect electrical connection via other devices and connections.

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Furthermore, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

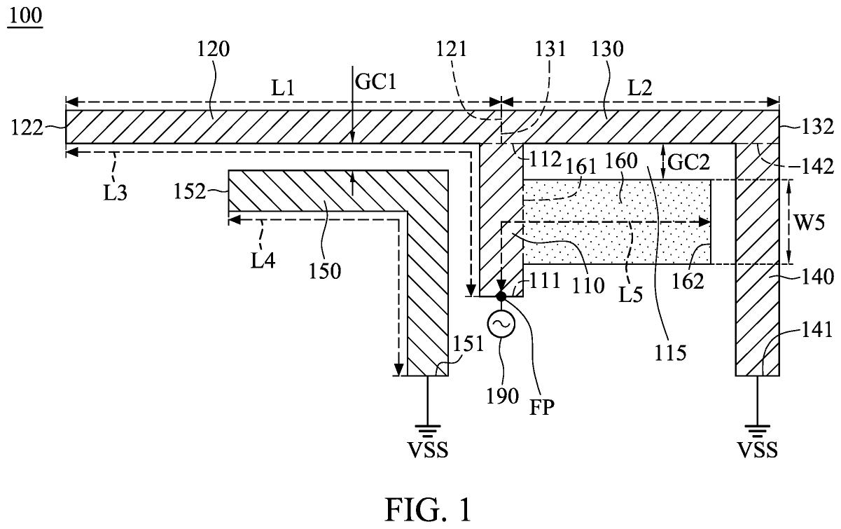

FIG. 1 is a top view of a mobile device 100 according to an embodiment of the invention. For example, the mobile device 100 may be a smartphone, a tablet computer, or a notebook computer. As shown in FIG. 1, the mobile device 100 at least includes a feeding radiation element 110, a first radiation element 120, a second radiation element 130, a shorting radiation element 140, a third radiation element 150, and a fourth radiation element 160. The feeding radiation element 110, the first radiation element 120, the second radiation element 130, the shorting radiation element 140, the third radiation element 150, and the fourth radiation element 160 may all be made of metal materials, such as copper, silver, aluminum, iron, or their alloys. It should be understood that the mobile device 100 may further include other components, such as a processor, a touch control panel, a speaker, a power supply module, and/or a housing, although they are not displayed in FIG. 1.

The combination of the feeding radiation element 110, the first radiation element 120, and the second radiation element 130 may substantially have a T-shape. Specifically, the feeding radiation element 110 has a first end 111 and a second end 112. A feeding point FP is positioned at the first end 111 of the feeding radiation element 110. The feeding point FP may also be coupled to a signal source 190. For example, the signal source 190 may be an RF (Radio Frequency) module.

The first radiation element 120 may substantially have a relatively long straight-line shape. Specifically, the first radiation element 120 has a first end 121 and a second end 122. The first end 121 of the first radiation element 120 is coupled to the second end 112 of the feeding radiation element 110. The second end 122 of the first radiation element 120 is an open end.

The second radiation element 130 may substantially have a relatively short straight-line shape (compared with the first radiation element 120). Specifically, the second radiation element 130 has a first end 131 and a second end 132. The first end 131 of the second radiation element 130 is coupled to the second end 112 of the feeding radiation element 110. In addition, the second end 132 of the second radiation element 130 and the second end 122 of the first radiation element 120 may substantially extend in opposite directions and away from each other.

The shorting radiation element 140 may substantially have a straight-line shape, which may be substantially parallel to the feeding radiation element 110. Specifically, the shorting radiation element 140 has a first end 141 and a second end 142. The first end 141 of the shorting radiation element 140 is coupled to a ground voltage VSS. The second end 142 of the shorting radiation element 140 is coupled to the second end 132 of the second radiation element 130. In other words, the second radiation element 130 is coupled through the shorting radiation element 140 to the ground voltage VSS. For example, the ground voltage VSS may be provided by a ground copper foil. In some embodiments, the aforementioned ground copper foil is further coupled to a system ground plane (not shown) of the mobile device 100. The third radiation element 150 may substantially have a relatively long L-shape. Specifically, the third radiation element 150 has a first end 151 and a second end 152. The first end 151 of the third radiation element 150 is coupled to the ground voltage VSS. The second end 152 of the third radiation element 150 is an open end. For example, the second end 152 of the third radiation element 150 and the second end 122 of the first radiation element 120 may substantially extend in the same direction. The third radiation element 150 is adjacent to the first radiation element 120. A first coupling gap GC1 may be formed between the third radiation element 150 and the first radiation element 120. It should be noted that the term “adjacent” or “close” over the disclosure means that the distance (spacing) between two corresponding elements is smaller than a predetermined distance (e.g., 10 mm or shorter), but often does not mean that the two corresponding elements directly touch each other (i.e., the aforementioned distance/spacing therebetween is reduced to 0).

The fourth radiation element 160 may substantially have a rectangular shape. Specifically, the fourth radiation element 160 has a first end 161 and a second end 162. The first end 161 of the fourth radiation element 160 is coupled to the feeding radiation element 110. The second end 162 of the fourth radiation element 160 is an open end, which may extend toward the shorting radiation element 140. The fourth radiation element 140 is adjacent to the second radiation element 130. A second coupling gap GC2 may be formed between the fourth radiation element 160 and the second radiation element 130. In some embodiments, the fourth radiation element 160 is positioned inside a notch region 115, which is defined by the feeding radiation element 110, the second radiation element 130, and the shorting radiation element 140.

In a preferred embodiment, an antenna structure of the mobile device 100 is formed by the feeding radiation element 110, the first radiation element 120, the second radiation element 130, the shorting radiation element 140, the third radiation element 150, and the fourth radiation element 160. For example, the aforementioned antenna structure may be a planar antenna structure. However, the invention is not limited thereto. In alternative embodiments, the aforementioned antenna structure is modified to a 3D (Three-Dimensional) antenna structure. According to practical measurements, the antenna structure of the mobile device 100 can cover the wideband operations of the next 5G (5th Generation Wireless System) communication.

The following embodiments will introduce different configurations and detailed structural features of the mobile device 100. It should be understood that these figures and descriptions are merely exemplary, rather than limitations of the invention.

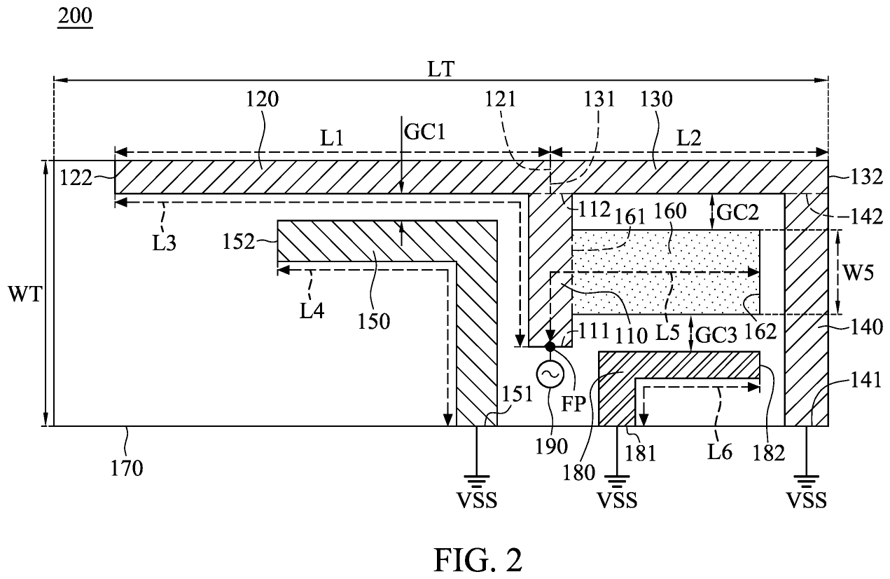

FIG. 2 is a top view of a mobile device 200 according to an embodiment of the invention. FIG. 2 is similar to FIG. 1. In the embodiment of FIG. 2, the mobile device 200 further includes a dielectric substrate 170 and a fifth radiation element 180. The dielectric substrate 170 may be implemented with an FR4 (Flame Retardant 4) substrate, a PCB (Printed Circuit Board), or an FPC (Flexible Printed Circuit). The fifth radiation element 180 may be made of a metal material. The feeding radiation element 110, the first radiation element 120, the second radiation element 130, the shorting radiation element 140, the third radiation element 150, the fourth radiation element 160, and the fifth radiation element 180 are all disposed on the same surface of the dielectric substrate 170, so as to form a planar antenna structure of the mobile device 200.

The fifth radiation element 180 may substantially have a relatively short L-shape (compared with the third radiation element 150). Specifically, the fifth radiation element 180 has a first end 181 and a second end 182. The first end 181 of the fifth radiation element 180 is coupled to the ground voltage VSS. The second end 182 of the fifth radiation element 180 is an open end, which may extend toward the shorting radiation element 140. For example, the second end 182 of the fifth radiation element 180 and the second end 162 of the fourth radiation element 160 may substantially extend in the same direction. The fifth radiation element 180 is adjacent to the fourth radiation element 160. A third coupling gap GC3 may be formed between the fifth radiation element 180 and the fourth radiation element 160. Other features of the mobile device 200 of FIG. 2 are similar to those of the mobile device 100 of FIG. 1. Accordingly, the two embodiments can achieve similar levels of performances.

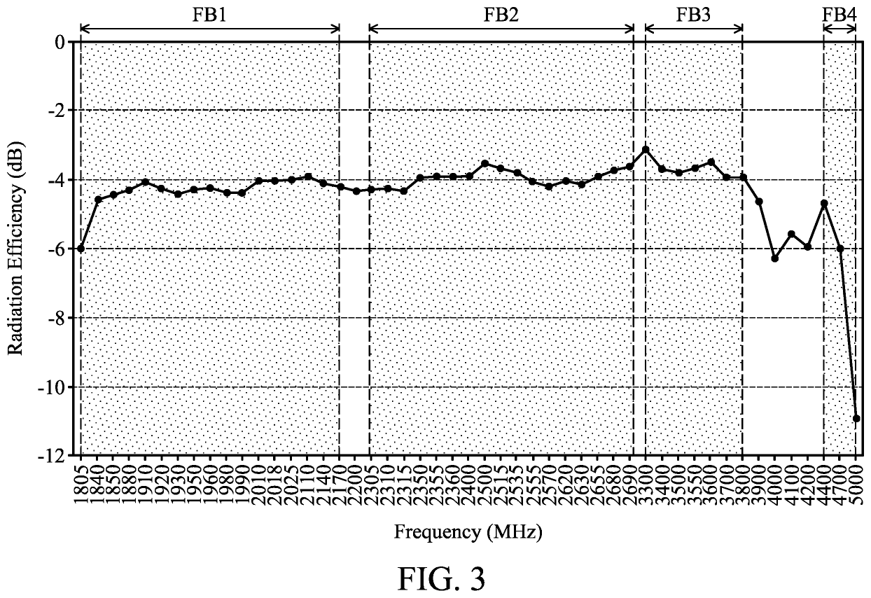

FIG. 3 is a diagram of radiation efficiency of the antenna structure of the mobile device 200 (or 100) according to an embodiment of the invention. The horizontal axis represents the operational frequency (MHz), and the vertical axis represents the radiation efficiency (dB). According to the measurement of FIG. 3, the antenna structure of the mobile device 200 can cover a first frequency band FB1, a second frequency band FB2, a third frequency band FB3, and a fourth frequency band FB4. For example, the first frequency band FB1 may be from 1805 MHz to 2170 MHz, the second frequency band FB2 may be from 2300 MHz to 2700 MHz, the third frequency band FB3 may be from 3300 MHz to 3800 MHz, and the fourth frequency band FB4 may be from 4400 MHz to 5000 MHz. Therefore, the mobile device 200 can support at least the wideband operations of the next 5G communication.

In some embodiments, the operational principles of the antenna structure of the mobile device 200 (or 100) will be described as follows. The first radiation element 120 and the second radiation element 130 are excited to generate the aforementioned first frequency band FB1. The feeding radiation element 110 and the first radiation element 120 are excited to generate the aforementioned second frequency band FB2. The third radiation element 150 is excited to generate the aforementioned third frequency band FB3. The feeding radiation element 110 and the fourth radiation element 160 are excited to generate the aforementioned fourth frequency band FB4. In addition, the fifth radiation element 180 is configured to fine-tune the impedance matching of the aforementioned fourth frequency band FB4. According to practical measurements, the proposed design of the invention can help to reduce the overall length LT of the antenna structure by at least 20%.

In some embodiments, the element sizes of the mobile device 200 (or 100) will be described as follows. The total length (L1+L2) of the first radiation element 120 and the second radiation element 130 may be substantially equal to 0.25 wavelength (λ/4) of the first frequency band FB1 of the antenna structure of the mobile device 200. The ratio (L1/L2) of the first radiation element 120's length to the second radiation element 130's length may be from 1.5 to 2. The total length L3 of the feeding radiation element 110 and the first radiation element 120 may be substantially equal to 0.25 wavelength (λ/4) of the second frequency band FB2 of the antenna structure of the mobile device 200. The length L4 of the third radiation element 150 may be substantially equal to 0.25 wavelength (λ/4) of the third frequency band FB3 of the antenna structure of the mobile device 200. The total length L5 of the feeding radiation element 110 and the fourth radiation element 160 may be substantially equal to 0.25 wavelength (λ/4) of the fourth frequency band FB4 of the antenna structure of the mobile device 200. The width W5 of the fourth radiation element 160 may be from 2 mm to 3 mm, and it may be greater than that of each of the other radiation elements. The length L6 of the fifth radiation element 180 may be substantially equal to 0.25 wavelength (λ/4) of the fourth frequency band FB4 of the antenna structure of the mobile device 200. The width of the first coupling gap GC1 may be from 0.5 mm to 1 mm. The width of the second coupling gap GC2 may be from 0.5 mm to 1 mm. The width of the third coupling gap GC3 may be from 0.5 mm to 1 mm. The overall length LT of the antenna structure of the mobile device 200 may be about 35 mm (the overall length of a conventional design may be about 45 mm). The overall width WT of the antenna structure of the mobile device 200 may be about 8 mm. The above ranges of element sizes and parameters are calculated and obtained according to many experiment results, and they help to optimize the operational bandwidth and impedance matching of the antenna structure of the mobile device 200.

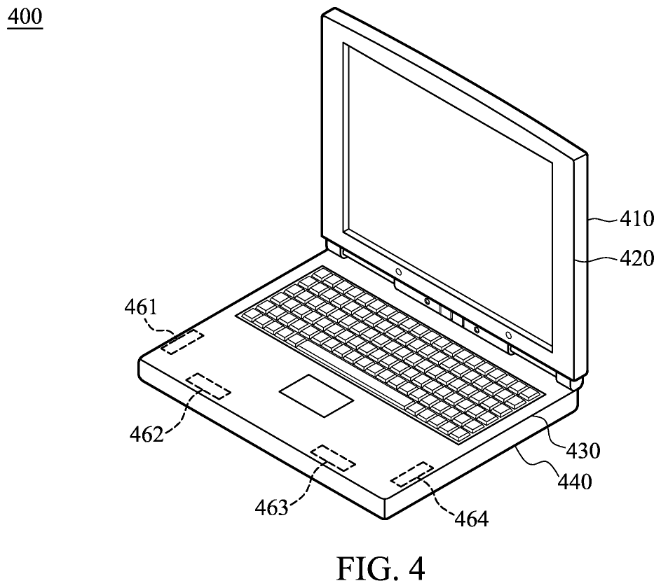

FIG. 4 is a perspective view of a notebook computer 400 according to an embodiment of the invention. In the embodiment of FIG. 4, the aforementioned antenna structure is applied in a notebook computer 400. The notebook computer 400 includes an upper housing 410, a display frame 420, a keyboard frame 430, and a base housing 440. It should be understood that the upper housing 410, the display frame 420, the keyboard frame 430, and the base housing 440 are respectively equivalent to the so-called “A-component”, “B-component”, “C-component”, and “D-component” in the field of notebook computers. The aforementioned antenna structure may be disposed at a second position 462 of the notebook computer 400, and it may be covered by the nonconductive keyboard frame 430. According to practical measurements, since the size of the entire antenna of the invention is very small, the proposed design can be applied in a variety of small-size mobile devices, and it can also ensure good communication quality and operational bandwidth. In alternative embodiments, a variety of antenna elements are disposed at a first position 461, a third position 463, and a fourth position 464, so as to support the wideband operations of MIMO (Multi-Input and Multi-Output).

The invention proposes a novel mobile device with a novel antenna structure. In comparison to the conventional design, the invention has several advantages, including its small size, wide bandwidth, high radiation efficiency, and low manufacturing cost. Therefore, the invention is suitable for application in a variety of mobile communication devices.

Note that the above element sizes, element shapes, and frequency ranges are not limitations of the invention. An antenna designer can fine-tune these settings or values according to different requirements. It should be understood that the mobile device of the invention is not limited to the configurations of FIGS. 1-4. The invention may merely include any one or more features of any one or more embodiments of FIGS. 1-4. In other words, not all of the features displayed in the figures should be implemented in the mobile device of the invention.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

While the invention has been described by way of example and in terms of the preferred embodiments, it should be understood that the invention is not limited to the disclosed embodiments. On the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A mobile device supporting wideband operations, comprising:
a feeding radiation element, having a feeding point;
a first radiation element, coupled to the feeding radiation element;
a second radiation element, coupled to the feeding radiation element, wherein the second radiation element and the first radiation element substantially extend in opposite directions;
a shorting radiation element, wherein the second radiation element is coupled through the shorting radiation element to a ground voltage;
a third radiation element, coupled to the ground voltage, wherein the third radiation element is adjacent to the first radiation element; and
a fourth radiation element, coupled to the feeding radiation element, wherein the fourth radiation element is adjacent to the second radiation element;
wherein an antenna structure is formed by the feeding radiation element, the first radiation element, the second radiation element, the shorting radiation element, the third radiation element, and the fourth radiation element.

2. The mobile device as claimed in claim 1, wherein a combination of the feeding radiation element, the first radiation element, and the second radiation element substantially has a T-shape.

3. The mobile device as claimed in claim 1, further comprising:
a fifth radiation element, coupled to the ground voltage, wherein the fifth radiation element is adjacent to the fourth radiation element.

4. The mobile device as claimed in claim 3, further comprising:
a dielectric substrate, wherein the feeding radiation element, the first radiation element, the second radiation element, the shorting radiation element, the third radiation element, the fourth radiation element, and the fifth radiation element are disposed on the dielectric substrate.

5. The mobile device as claimed in claim 3, wherein a first coupling gap is formed between the third radiation element and the first radiation element.

6. The mobile device as claimed in claim 5, wherein a second coupling gap is formed between the fourth radiation element and the second radiation element.

7. The mobile device as claimed in claim 6, wherein a third coupling gap is formed between the fifth radiation element and the fourth radiation element.

8. The mobile device as claimed in claim 7, and wherein a width of each of the first coupling gap, the second coupling gap, and the third coupling gap is from 0.5 mm to 1 mm.

9. The mobile device as claimed in claim 3, wherein the antenna structure covers a first frequency band, a second frequency band, a third frequency band, and a fourth frequency band.

10. The mobile device as claimed in claim 9, wherein the first frequency band is from 1805 MHz to 2170 MHz, and the second frequency band is from 2300 MHz to 2700 MHz.

11. The mobile device as claimed in claim 9, wherein the third frequency band is from 3300 MHz to 3800 MHz, and the fourth frequency band is from 4400 MHz to 5000 MHz.

12. The mobile device as claimed in claim 9, wherein a total length of the first radiation element and the second radiation element is substantially equal to 0.25 wavelength of the first frequency band.

13. The mobile device as claimed in claim 9, wherein a total length of the feeding radiation element and the first radiation element is substantially equal to 0.25 wavelength of the second frequency band.

14. The mobile device as claimed in claim 9, wherein a length of the third radiation element is substantially equal to 0.25 wavelength of the third frequency band.

15. The mobile device as claimed in claim 9, wherein a length of the fifth radiation element is substantially equal to 0.25 wavelength of the fourth frequency band.
